(19) United States
(12) Patent Application Publication
(10) Pub. No.: US 2008/0193686 A1
(43) Pub. Date: Aug. 14, 2008

(54) Multiple Glazing With Improved Selectivity

(75) Inventors: Marcus Loergen, Herzogenrath (DE); Ariane Blanchard, Aachen (DE); Manfred Jansen, Geilenkirchen (DE); Klaus Fischer, Alsdorf (DE); Michael Labrot, Aachen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Saint-Gobain Glass France, Courbevoie (FR)

(21) Appl. No.: 11/911,057

(22) PCT Filed: Apr. 6, 2006
(86) PCT No.: PCT/FR2006/050307

§ 371 Date: Feb. 27, 2008

(30) Foreign Application Priority Data
Apr. 9, 2005 (DE) 102005016389.0

(51) Int. Cl. E06B 3/67

(52) U.S. Cl. 428/34

(57) ABSTRACT

The invention relates to laminated glazing intended to close a window opening and consisting of an external solid pane and an internal solid pane, which are joined together by means of an interlayer. A multilayer system partially transparent to visible radiation is placed on the inside of the laminated glazing. The laminated glazing according to the invention is characterized in that the panes are tinted and absorb some of the infrared radiation, and in that the multilayer system selectively reflects and/or absorbs the infrared radiation. The laminated glazing is particularly suitable for being used as side windows, tail gate or sunroof in vehicles or aircraft.

The invention relates to laminated glazing having the features of the preamble of claim 1 and to the use of this laminated glazing.

Glazing made up of laminated panes are widely used in vehicles and buildings. They provide several functions therein, for example they close off openings and eliminate the risk of injury should they be destroyed. Furthermore, such glazing must often, on the one hand, not let through all of the incident solar radiation, in order not to excessively heat up the interior, and, on the other hand, let through a sufficiently large amount of light, in order to illuminate the interior sufficiently. Meeting these two requirements, namely that of preventing excessive ingress of energetic radiation and of illuminating the interior sufficiently, involves a compromise. There is therefore a requirement to have laminated glazing with increased selectivity in terms of transparency to energy and transparency to light.

To meet said requirements, it is possible to use, for example, what are called solar protection layers that reflect some of the infrared radiation. It is also known to use tinted glass or glass that absorbs the radiation and filters out certain frequencies of the incident radiation spectrum.

German patent DE 199 27 683 C1 discloses transparent glazing made of laminated glass consisting of at least two solid glass panes and a transparent linking layer that connects them together, the glazing made up from laminated glass being provided with a solar protection layer that reflects the infrared radiation. The glazing made of laminated glass is characterized in that another transparent layer that essentially reflects thermal radiation is provided on its surface turned toward the interior. In addition to its solar protection function against infrared radiation of short and medium wavelength incident from the outside, the laminated glazing also fulfills a thermal protection function. The solar protection layer by is particularly effective when the layers of the laminated glazing placed in front of the solar protection layer are transparent. The thermal protection function is obtained by reflection of the long-wavelength infrared radiation coming from the interior so as to send it back into the interior.

German patent specification DE 102 49 263 B4 discloses glazing providing a thermal comfort effect, which comprises a self-darkening glass pane and a low-E layer, the low-E layer being placed on the surface turned toward the interior of the vehicle. In summer, the low-E layer has the effect of reducing the temperature of radiation from the glass surface to the interior of the vehicle. In winter, the low-E layer must have the effect of reflecting the infrared radiation emitted by the passengers of the vehicle back into the interior of the vehicle. In one embodiment, the glazing consists of four layers, namely, starting from the outside, a first glass pane, an SPD (suspended particle device) sheet, which has a darkening effect, a second glass sheet and a low-E layer placed on the latter and turned toward the interior of the vehicle.

Document WO 2005/012200 A1 discloses a transparent substrate with a low solar coefficient and provided with a multilayer system. The multilayer system consists, starting from the substrate, of a first layer of a dielectric, a first absorbent layer, a layer that reflects infrared radiation, a second absorbent layer and a sealing layer made of a dielectric. The light absorption by the coated substrate must be 35% or higher when the substrate is a transparent pane made of soda-lime glass with a thickness of 6 mm.

The basic problem of the invention is how to provide laminated glass that is easy to manufacture and gives an enhanced sensation of thermal comfort.

According to the invention, this problem is solved by the features of claim 1. The features of the dependent claims give advantageous developments of this subject matter.

The laminated glazing according to the invention therefore consists of two individual tinted panes, which absorb the radiation and are joined together by means of an interlayer, a multilayer system, which lets through visible light within a defined frame, being placed on the inside of the laminated glazing. That part of the radiation which strikes the multilayer system and does not pass through it is reflected or absorbed or reflected and absorbed by this multilayer system depending on its nature and its structure. The multilayer system therefore acts selectively on the spectrum of the incident radiation.

In addition, the individual tinted panes absorb another part of the infrared radiation, whereas the visible light is not absorbed to the same extent. The individual panes therefore have a selective effect. Specifically, thanks to its multiple filtering effect, by which the infrared radiation, in particular the near infrared radiation, is prevented to a greater extent from penetrating into the interior in the form of visible light, the laminated glazing according to the invention possesses a higher selectivity than the laminated glazing normally used or than the known individual tinted panes.

Surprisingly, in the invention it is possible to dispense with a transparent pane located in front of the multilayer system in the direction of incidence of the radiation, whereas this pane is considered as indispensable in order to increase the effectiveness of known glass laminated panes provided with metal-based solar protection layers. In many cases, even untinted glass compositions with a low iron content, in order to absorb as little infrared radiation as possible in the glass pane turned toward the exterior, are used. This necessarily increases the effect of the multilayer system.

The multilayer system used in the laminated glazing according to the invention is transparent to the total energy T_{E} of the radiation to a level of between 8% and 35%. The term “total energy of the radiation” is understood here to mean the solar radiation in the wavelength range between 250 nm and 2500 nm. A proportion of between 92% and 65% of the total energy of the radiation is therefore reflected (R_{E}) and/or absorbed (A_{E}), the ratio of R_{E} to A_{E} being determined by the nature and the structure of the multilayer system. The total radiation that passes through the glazing obviously also contains visible light in the wavelength range between 350 nm and 750 nm. Depending on the nature of the thin-film multilayer system, the transmission T_{L} in the visible range is between 5% and 75%.

The individual panes of the laminated glazing according to the invention may have different tints or absorptivities in order to obtain defined effects, such as transparency to the total light or the color perceived through the glazing. In particular the external pane may be less tinted than the internal pane in order to increase the effect of the multilayer system in terms of blocking the infrared radiation and at the same time obtaining a defined overall tint or an overall absorption of the laminated glazing by using a more highly tinted internal glass pane.

Similar effects may be obtained with panes of different thicknesses. However, it is also possible to adapt the mechanical properties of the laminated glazing for a particular application by using individual panes having different thicknesses.

The multilayer system may be applied to the external pane, to the internal pane or to the interlayer, provided that it is placed on the inside of the laminated glazing. As multilayer system, a thin-film multilayer system known per se, having one or more functional silver layers and appropriate blocking and interference layers, is preferred. These thin-film multilayer systems are usually deposited on the substrate by vacuum coating (for example magnetron sputtering or PVD processes). The thickness of these individual layers, and also the coating materials used, may be adapted to the particular use in laminated glazing according to the invention.

The individual panes used in the laminated glazing according to the invention may be made of glass, glass-ceramic or a plastic, for example polycarbonate.

The individual panes of the laminated glazing according to the invention are preferably made of glass so as to form, with the interlayer that joins the two panes together, laminated glazing made of safety glass. Preferably, the panes will have a thickness of between 1 mm and 5 mm. For weight-saving reasons, the panes must make it possible to achieve as good a compromise as possible between a small thickness and good stability, in particular when the laminated glazing is fitted into an automobile. Such a compromise may be achieved with panes having a thickness of between 1.6 mm and 3.1 mm. For laminated safety glass, polyvinyl butyral (PVB) has proved to be a very suitable material for the interlayer and, in most cases, is used in thicknesses of 0.38 mm or 0.76 mm.

The total thickness of the laminated glazing, comprising the glass panes and the PVB as intermediate bonding layer, is therefore within a preferred range of between about 3.6 mm and 7 mm.

In addition to PVB, any other material suitable for the interlayer may of course also be used, for example thermoplastics such as ethylene/vinyl acetate (EVA) copolymers, polyurethane (PU) or polyvinyl chloride (PVC). Casting resins may equally well be used for joining the individual panes together.

Tinted glass panes that absorb infrared radiation are known in various glass thicknesses, depth of tint and color. Thus, the Applicant offers, for example, with the names SGS THERMOCONTROL® Venus Green, SGS THERMOCONTROL® Venus Gray and SGS THERMOCONTROL® Absorbing TSA3+, glasses that are bulk-tinted green or gray, with various depths of tint and with various thicknesses, making it possible to obtain various transmission values. In these names, SGS stands for Saint-Gobain Sekurit.

When glass panes and a PVB sheet for connecting them are used and when the interlayer has to be provided with the multilayer system, an additional support sheet must be used for the multilayer system because the plastic PVB sheet can be coated only with great difficulty. For this purpose, a polyethylene terephthalate (PET) support sheet has proved to be very suitable, this being incorporated between two PVB sheets after it has been coated. In this way, a three-layer sheet is obtained which serves as interlayer for joining the individual panes together as laminated glazing.

In addition to partially-transparent thin-film multilayer systems comprising functional layers made of metal (silver, gold, copper, alloyed steel etc.), thin-film multilayer systems based on other materials are also known, for example those based on metal oxides, for example indium-doped tin oxide. Such a thin-film multilayer system is also fundamentally suitable to be used in laminated glazing according to the invention. In addition, there also exist on the market reflecting and/or absorbent thin-film multilayer systems that do not contain electrically conducting functional layers but form, individually, an interference multilayer system by means of a plurality of individual layers having different refractive indices. The company 3M for example offers a sheet provided with such a multilayer system with the name 3M™ Solar Reflecting Film (SRF).

In one preferred embodiment, the laminated glazing according to the invention reflects up to 50% of the visible radiation incident on the external side by appropriate selection of the multilayer system and of the panes used. Seen from the outside, the laminated glazing then has the appearance of a partial mirror. If required, the reflecting colors of the multilayer system used may be modified or softened by tinting the external glass pane. This is particularly useful when certain color effects are undesirable or when the external appearance upsets the association with other components close by.

In addition to the panes being tinted to a greater or lesser extent, the interlayer may also have its own tint and/or exert an infrared radiation absorption effect. When the interlayer has to increase the infrared radiation absorption effect of the external pane, it must obviously be placed in front of the multilayer system when it is seen from the outside. It is only in this sequence that the reflection colors of the interlayer can be further modified and can be acted upon.

It should be pointed out here that it is possible to act upon the laminated glazing according to the invention both in terms of reflected color, when it is observed from the outside and/or from the inside, and in terms of the color in which it appears when an observer looks through it. This is achieved, on the one hand, by coloring the individual panes used and the interlayer, and, on the other hand, by appropriately selecting the sequence of thicknesses and materials.

In one appropriate combination of tinted panes and/or of infrared-radiation-absorbent panes (and optionally of a tinted and/or infrared-radiation-absorbent interlayer) with the multilayer system that selectively reflects or absorbs infrared radiation, the laminated glazing according to the invention has overall a high selectivity. The selectivity is defined by a ratio (T_{L}/T_{E}), between the transmitted light T_{L} and the transmitted energy T_{E}, of greater than 1.8. Preferably, a selectivity of greater than 2.4 will be established.

In certain applications and most particularly in automobile applications, it may be necessary to curve the laminated glazing along one or two dimensions. When the laminated glazing consists of individual glass panes, the multilayer system will preferably be thermostable so as to be able firstly to coat a flat glass pane with the multilayer system and then to bend it and/or thermally prestress it (partially) at temperatures between 500° C. and 640° C. Although coating processes are also known by which it is possible to coat a bent or heat-treated glass pane in another manner, these processes require greater logistic processing and cannot be integrated into the manufacturing procedure for laminated glazing made of safety glass except with more extensive processing.

In addition to its incorporation into buildings, the laminated glazing according to the invention is suitable for being used as sunroofs, side windows or rear windows of vehicles. When such glazing is used as side windows beyond the B column, the legal requirement imposing a minimum transmission of 75% within the visible wavelength range is no longer applicable, at least in Germany. In the present invention, the light transmission appearance of the glazing is secondary and the priority is that the laminated glazing give an increased thermal comfort feeling and a certain brightness inside the vehicle, the enhanced thermal comfort being obtained by means of a high selectivity in terms of light transmission and energy transmission.

Other details and advantages of the subject of the invention will become apparent from the nonlimiting embodiment examples that follow.

Table 1 shows the structure of the multilayer system used in the laminated glazing tested in the comparative example and in the two embodiment examples 1 and 2. Table 1 also shows the types of glass used. The multilayer systems, which all have two silver functional layers, were deposited using a vacuum deposition process on the internal surfaces of the individual panes of the laminated glazing. It is usual to coat the internal pane because in this way a border layer, which may possibly be necessary in order to prevent corrosion, can be masked when viewed from the outside by means of an opaque edge coating applied to the inner surface of the external pane. When glass panes are used, the edge coating generally consists of a colored ceramic which is printed and then fired. If it is unnecessary to deposit an edge coating or a mask, for example when the laminated glazing is held in a prefabricated frame or when it has been provided with a plastic frame by injection molding or extrusion, the multilayer system may of course also be applied to the inner surface of the external pane.

TABLE 1
Structure of the layers and glasses used for the laminated glazing

| | | | | | | | | | | | | | Trans- | |
|---|---|---|---|---|---|---|---|---|---|---|---|---|---|---|
| | Internal | | | | | | | | | | | | parent | External |
| | glass | Si₃N₄ | ZnO | Ti | Ag | ZnO | Si₃N₄ | ZnO | Ti | Ag | ZnO | Si₃N₄ | PVB | glass |
| Compar- | PLX | 22 nm | 10 nm | 0.5 nm | 8 nm | 10 nm | 63 nm | 10 nm | 0.5 nm | 10 nm | 10 nm | 25 nm | 0.76 mm | PLX |
| ative | | | | | | | | | | | | | | |
| example | | | | | | | | | | | | | | |
| Embod- | VV55 | 75 nm | 10 nm | 0.5 nm | 17.5 nm | 10 nm | 75 nm | 10 nm | 0.5 nm | 27.5 nm | 10 nm | 35 nm | 0.76 mm | VG10 |
| iment | 2.1 mm | | | | | | | | | | | | | 2.1 mm |
| example 1 | | | | | | | | | | | | | | |
| Embod- | VG 40 | 135 nm | 10 nm | 0.5 nm | 13.5 nm | 10 nm | 72 nm | 10 nm | 0.5 nm | 26.5 nm | 10 nm | 150 nm | 0.76 mm | TSA + 3 |
| iment | 3 mm | | | | | | | | | | | | | 2.1 mm |
| example 2 | | | | | | | | | | | | | | |

Various types of glass are used in the laminated glazing, the abbreviations having the meanings given below:
PLX→usual transparent glass;
TSA3+→glass tinted dark green;
VG40→glass tinted very dark green;
VG10→Venus Gray, glass tinted very dark gray; and
VV55→Venus Green, glass strongly tinted dark green.

The light and energy transmission values of said glasses for a standard thickness of 3.15 mm are given in Table 2.

TABLE 2
Light transmission and energy transmission of
glasses with a thickness of 3.15 mm

| Name of the glass | T_{L} (%) | T_{E} (%) |
|---|---|---|
| SGS THERMOCONTROL ® Venus Green 55 | 55 | 32 |
| (VV55) | | 25 |
| SGS THERMOCONTROL ® Venus Gray 40 (VG40) | 42 | 28 |
| SGS THERMOCONTROL ® Venus Gray 10 (VG10) | 15 | 12 |
| SGS THERMOCONTROL ® Absorbing TSA3+ | 71 | 49 |
| (TSA3+) | | |
| SGS PLANILUX ® (PLX) | 90 | 84 |

Table 3 gives the optical properties, namely the light transmission T_{L}, the energy transmission T_{E}, the selectivity T_{L}/T_{E}, the light reflection R_{L} and the energy reflection R_{E} of the laminated glazing of the comparative example and of the embodiment examples.

TABLE 3
Optical properties of the laminated glazing

| | T_{L} | T_{E} | T_{L}/T_{E} | R_{L} | R_{E} |
|---|---|---|---|---|---|
| Comparative example | 76.0 | 45.0 | 1.7 | 11.0 | 31.0 |
| Embodiment example 1 | 9.6 | 4.1 | 2.3 | 5.5 | 7.3 |
| Embodiment example 2 | 24.8 | 8.9 | 2.8 | 46.4 | 35.6 |

Table 3 clearly shows that the selectivity T_{L}/T_{E} is considerably higher in the laminated glazing of the embodiment examples than in the laminated glazing of the comparative example. The laminated glazing of the comparative example is used mainly as solar protection glazing in automobile windshields and for this reason the value of the light transmission T_{L} must be set at 75% in order to comply with the legal requirements. In contradistinction to the usual assumptions that the ability of the solar protection layers increases when the pane turned toward the incident radiation absorbs as little radiation as possible, the laminated glazing according to the invention uses, on the contrary, absorbent panes that bring the selectivity to values considerably higher than the 1.7 of the comparative example by means of suitable thin-film multilayers. Because the light transparency is lower and below the set requirements for windshields, the laminated glazing according to the invention cannot be used as windshields but is, however, exceptionally well suited for sunroofs or for what is called “dark tail” glazing, namely for applications in which the total energy of the radiation is reduced while still letting through a certain quantity of light. The laminated glazing according to the invention is therefore particularly well suited as solar glazing and/or protective and screening glazing.

When a less absorbent glass is used for the external pane, the multilayer system makes the laminated glazing quite reflective. However, if the reflective multilayer system is combined with an absorbent glass external pane, the laminated glazing appears quite absorptive. The light absorption by the external pane thereby reduces the light reflection.

As already indicated, a multilayer system consisting of two functional silver layers separated from each other by a dielectric is used both in the present embodiment examples and in the comparative example. Other dielectric layers are applied between the glass and the lower silver layer and also on top of the upper silver layer. Thanks to these dielectric layers, firstly the multilayer system may inter alia partly provide an antireflection effect, thanks to interference effects, and secondly it is possible to vary colors in reflection and in transmission.

Further possibilities of varying the reflection and/or color effect of the multilayer system are provided by multilayer systems consisting of more than two functional layers. In this case, the larger number of dielectric interlayers also offers further possibilities of variation, so as to create not only reflecting layers but also antireflection layers. In particular, there is thus the possibility of adapting the color of the multilayer system to the customer's wishes. Often it is wished to have a neutral blue or gray color in reflection.

The figures given below illuminate once again the optical properties of certain of the individual panes used, both in the comparative example and the embodiment examples 1 and 2.

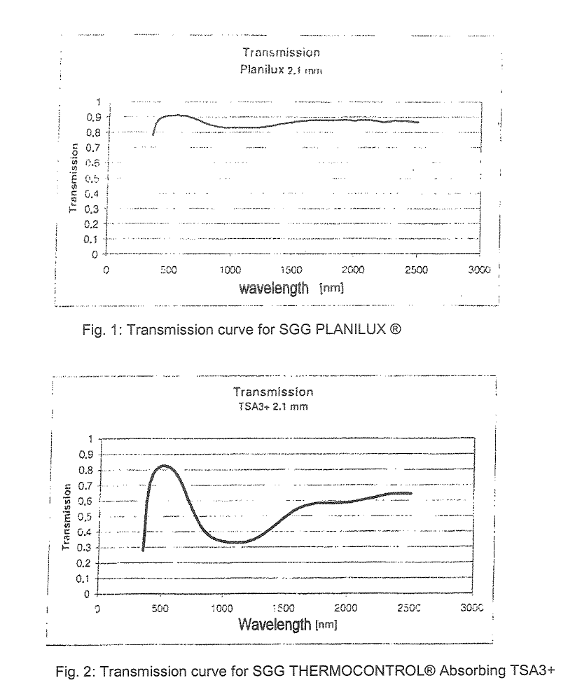

FIGS. 1 to 3 show, by way of example, the variation in the percentage transmission of the radiation as a function of the wavelength for certain individual panes used in the laminated glazing, namely for the glasses SGS PLANILUX®, SGS THERMOCONTROL® Absorbing TSA3+ and SGS THERMOCONTROL® Venus Gray 10 (VG10), each time for a glass thickness of 2.1 mm.

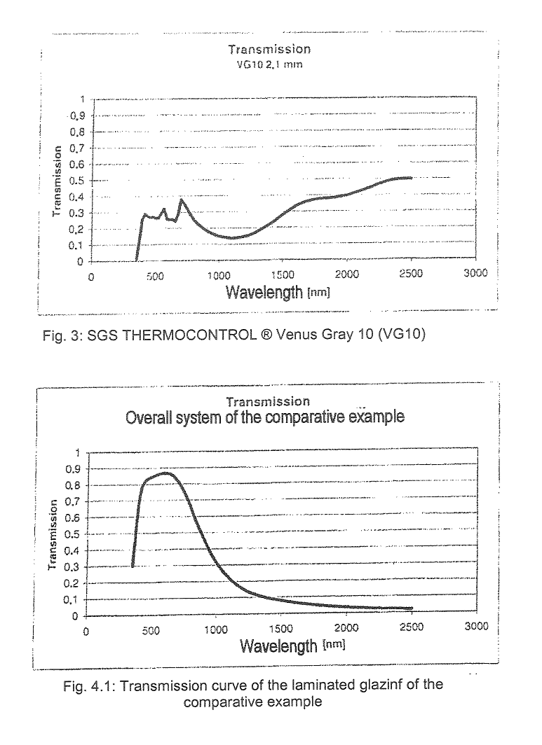

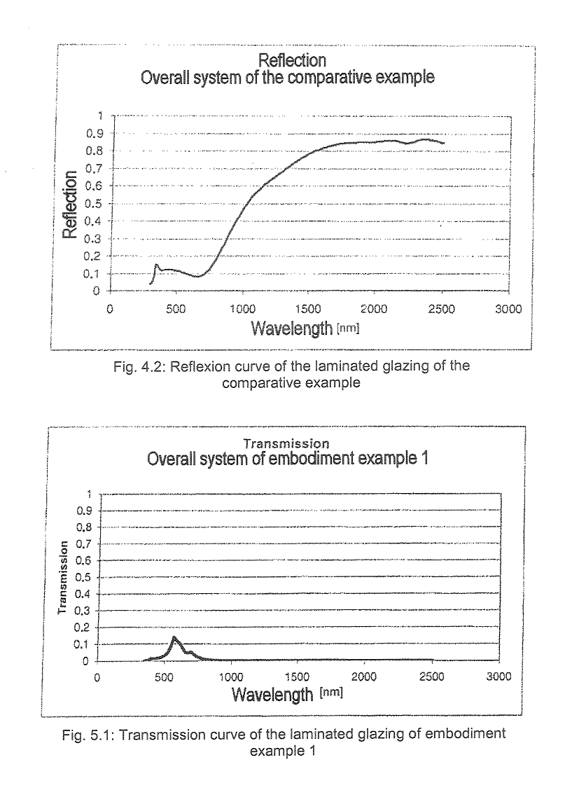

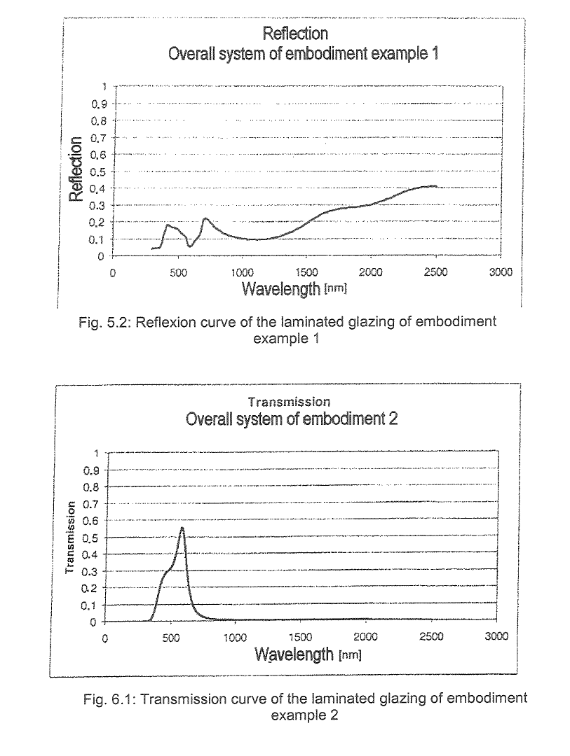

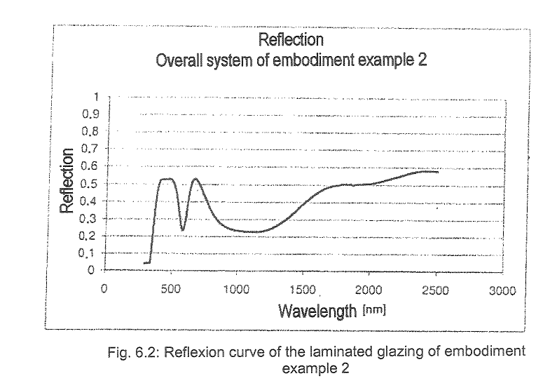

FIGS. 4.1 and 4.2 show the variation in the percentage transmission of the radiation and percentage reflection of the radiation as a function of the wavelength in the case of the comparative example. FIGS. 5.1 and 5.2 show the percentage transmission and reflection values for embodiment example 1 and FIGS. 6.1 and 6.2 for embodiment example 2.

In FIGS. 4 to 6, which show the optical values for the overall terminated glazing systems, it may be seen that, in the embodiment examples, the transmission is lower than in the comparative example, most particularly in the near infrared radiation range. Moreover, in the visible light range, the transmission is also lower, but, as already indicated, this is of no importance for the preferred application. In contrast, said reduced visible light transmission of the glazing for screening or for protection against being seen (i.e. “dark tail” glazing) is even desirable.

Relative to the comparative example, embodiment example 1 has both a lower transmission and a lower reflection in the visible range of the spectrum and thus absorptive laminated glazing of dark appearance is obtained.

In contrast, the figures for embodiment example 2 show that the reflection is relatively high in the visible range of the spectrum. In this case, the laminated glazing of embodiment example 2 has the appearance of laminated glass reflecting in the visible range.

Although the two embodiment examples appear to have very different effects, they nevertheless both have a high selectivity T_{L}/T_{E}, of 2.3 and 2.8 respectively.

By selecting an appropriate multilayer system or relatively strongly absorbent panes, the laminated glazing according to the invention allows the appearance of the laminated glazing to be controlled without in any way reducing the desired high selectivity.

1-20. (canceled)

21. A laminated glazing, configured to close a window opening, comprising:
an external solid pane and an internal solid pane, which are joined together by an interlayer; and
a multilayer system partially transparent to visible radiation placed on an inside of the laminated glazing,
wherein the panes are tinted and absorb some of infrared radiation and the visible radiation, and the multilayer system selectively reflects and/or absorbs the infrared radiation.

22. The laminated glazing as claimed in claim 21, wherein the multilayer system has an energy transmission of between 8% and 35%.

23. The laminated glazing as claimed in claim 21, wherein the panes are relatively highly tinted and/or absorb infrared radiation to different degrees.

24. The laminated glazing as claimed in claim 23, wherein the external pane is less highly tinted or has a lower capability of absorbing infrared radiation than the internal pane.

25. The laminated glazing as claimed in claim 21, wherein the panes have different thicknesses.

26. The laminated glazing as claimed in claim 21, wherein the external pane includes the multilayer system.

27. The laminated glazing as claimed in claim 21, wherein the internal pane includes the multilayer system.

28. The laminated glazing as claimed in claim 21, wherein the interlayer includes the multilayer system

29. The laminated glazing as claimed in claim 21, wherein the panes are made of glass and have a thickness of between 1 mm and 5 mm, or between 1.6 mm and 3.1 mm.

30. The laminated glazing as claimed in claim 21, wherein the interlayer includes two polyvinyl butyral sheets between which a polyethylene terephthalate sheet provided with the multilayer system is placed.

31. The laminated glazing as claimed in claim 21, wherein the multilayer system is a thin-film multilayer system having one or more functional silver layers.

32. The laminated glazing as claimed in claim 21, wherein the multilayer system is a nonmetallic-based filtering multilayer system or is an interference multilayer system.

33. The laminated glazing as claimed in claim 21, reflecting up to 50% of the visible radiation incident from outside.

34. The laminated glazing as claimed in claim 21, wherein the external pane absorbs at least some of reflection colors of the multilayer system.

35. The laminated glazing as claimed in claim 21, wherein the interlayer is tinted and/or at least partly absorbs the infrared radiation.

36. The laminated glazing as claimed in claim 30, wherein, seen from outside, the multilayer system is placed at a rear of the tinted and/or infrared-radiation-absorbent interlayer, and the interlayer absorbs at least some of the visible reflection colors of the multilayer system.

37. The laminated glazing as claimed in claim 21, wherein a ratio of light transmission to energy transmission, T_{L}/T_{E}, is greater than 1.8 or is greater than 2.4.

38. The laminated glazing as claimed in claim 21, wherein the laminated glazing is curved.

39. The laminated glazing as claimed in claim 38, wherein the panes are made of glass, the multilayer system partially transparent to visible radiation is placed on one of the panes, and the multilayer system may be thermally stressed.

40. The use of the laminated glazing as claimed in claim 21 as a side window, a tail gate, or a sunroof for a vehicle or aircraft.
